(19) United States
(12) Patent Application Publication
(10) Pub. No.: US 2025/0112511 A1
(43) Pub. Date: Apr. 3, 2025

(54) ELECTROMAGNETIC DEVICE

(71) Applicant: KOGAKUIN UNIVERSITY, Tokyo (JP)

(72) Inventor: Mimpei Morishita, Tokyo (JP)

(21) Appl. No.: 18/728,025

(22) PCT Filed: Jan. 13, 2023
(86) PCT No.: PCT/JP2023/000841

§ 371 Date: Jul. 10, 2024

(30) Foreign Application Priority Data
Jan. 13, 2022 (JP) 2022003866

(51) Int. Cl. H02K 1/2792

(52) U.S. Cl. CPC H02K 1/2792; H02K 2213/03

(57) ABSTRACT

An outside field system section and an inside field system section are provided to a stator of an electric motor to form a field system, with the outside field system section and the inside field system section formed in a substantially tube shape with permanent magnets arrayed in a circumferential direction while changing magnetization directions according to a division number n, wherein the division number n is an integer of 3 or more. A tube body employing a ferromagnetic material is disposed between the outside field system section and the inside field system section, with coils attached to the tube body. Coils in the electric motor are accordingly able to be efficiently cooled through the tube body.

### TECHNICAL FIELD

Technology disclosed herein relates to an electromagnetic device with armature coils disposed between a pair of magnet arrays.

### BACKGROUND ART

An electromagnetic induction device is disclosed in Japanese Patent Application Laid-Open (JP-A) No. 2015-027208, that employs first and second permanent magnet arrays, each having plural permanent magnets respectively arrayed such that their magnetic pole directions are progressively changed by an integer equal part of 2π, with armature coils disposed between the first permanent magnet array and the second permanent magnet array. The first and second permanent magnet arrays are called Halbach arrays. In a Halbach array, the magnetic field on one side of a direction intersecting with the array direction is weakened and the magnetic field on the other side thereof is strengthened, by progressively changing the magnetic pole directions of plural permanent magnets arrayed along a one direction by an integer equal part of 2π.

Adopting a so-called dual Halbach array in which the magnetic fields of the first permanent magnet array and the second permanent magnet array are caused to face toward the strengthened side, enables the number of lines of magnetic flux that link with the armature coils interposed between the first permanent magnet array and the second permanent magnet array to be larger (greater), thereby obtaining an electromagnetic induction device with large output.

Moreover, a rotary electrical machine with large output is obtained by forming the array directions of the permanent magnets in each of the first permanent magnet array and the second permanent magnet array in substantially circular rings shapes (circular cylinder shapes) so as to configure a circle shape, and by disposing the armature coil between the inside permanent magnet array and the outside permanent magnet array.

### SUMMARY OF INVENTION

### Technical Problem

However, in cases in which a dual Halbach array is applied in an electric motor, generally a field system is employed as a rotor side and an armature as the stator side. This means that in such an electric motor, the rotor is configured by a double-walled cylinder structure resulting from integrating an inner rotor and an outer rotor together.

However, heat generation occurs in the coils. This makes it difficult to dispose of the heat from the coils due to the coils being disposed inside the rotor (between the inner rotor and the outer rotor) in an electric motor having a double-walled cylinder structure, and heat disposal becomes an issue when power density is increased.

The present disclosure is in consideration of the above circumstances, and an object thereof is to provide an electromagnetic device in which raised power density is achieved by enabling efficient disposal of heat from an armature.

### Solution to Problem

In order to achieve the above object, an electromagnetic device of a first aspect includes: a moving body including a first magnet array and a second magnet array each in which a plurality of permanent magnets are arrayed along a one direction while progressively changing respective magnetization directions in sequence by an angle resulting from dividing one cycle of electric angle by a division number n, wherein the division number n is any number equal to or greater than 3, the first magnet array and the second magnet array are disposed separated by a specific gap length and facing at orientations such that magnetic fields of the first magnet array and the second magnet array reinforce each other; a fixed body including a support body formed at a specific thickness dimension using a ferromagnetic material, the support body disposed between the first permanent magnet array and the second permanent magnet array such that a gap length to the first magnet array is similar to a gap length to the second magnet array, the moving body being moved relative to the fixed body; and a three-phase armature configured from respective air-core coils disposed on the support body divided respectively between the first magnet array side and the second magnet

In the electromagnetic device of the first aspect, the first magnet array and the second magnet array are disposed in the moving body. The first magnet array and the second magnet array are each configured by a Halbach magnet array in which plural permanent magnets are arrayed along a one direction (specific direction) while progressively changing magnetization directions thereof in sequence by an angle resulting from dividing one cycle of electric angle by a division number n, wherein the division number n is any number of 3 or more. The first magnet array and the second magnet array are disposed separated by a specific gap length and facing at orientations such that magnetic fields of the first magnet array and the second magnet array reinforce each other. A dual Halbach magnet array is thereby formed in the moving body.

The fixed body that the moving body moves relative to includes the support body formed at a specific thickness dimension using a ferromagnetic material, and the support body is disposed between the first magnet array and the second magnet array. Moreover, the support body is configured such that a gap length to the first magnet array is similar to the gap length to the second magnet array.

Moreover, the support body supports the three-phase armature configured by respective air-core coils, with the armature disposed on the support body divided respectively between the first magnet array side and the second magnet array side of the support body.

Even though the support body is disposed between the first magnet array and the second magnet array, the ferromagnetic material having a higher magnetic permeability than air or the like is employed for the support body, and so there is no disturbance in the magnetic field formed by the first magnet array and the second magnet array. Moreover, the ferromagnetic material is a metal or the like, having a thermal conductivity that is extremely high compared air, and so each of the armatures can be cooled by cooling the support body.

This means that efficient cooling of the armature is possible, even though the armature are disposed between the first magnet array and the second magnet array that move relative to the armature, while removing a need to suppress a current value flowing in the armature more than necessary to suppress heat generation of the armature, and enabling an improved power density to be achieved.

In an electromagnetic device of a second aspect, in the first aspect, the division number n may be any number resulting from adding 2 to a multiple of 3.

Moreover, in an electromagnetic device of a third aspect, in the first or second aspect, the moving body is configured by a rotor in which the permanent magnets are arrayed in each of the first magnet array and the second magnet array along a circumferential direction centered on a single center point; and the fixed body is a circular cylinder shaped stator centered on the center point.

The electromagnetic device of the present disclosure exhibits effects of enabling efficient heat disposal of heat generated in the armature by using the support body even though the armature is disposed between the first magnet array and the second magnet array, and of enabling an improved power density to be achieved.

### BRIEF DESCRIPTION OF DRAWINGS

FIG. 1 is a perspective view illustrating main parts of an electric motor according to the present exemplary embodiment.

FIG. 2A is a plan view illustrating main parts of a rotor of an electric motor.

FIG. 2B is a plan view illustrating main parts of a rotor of an electric motor.

FIG. 3 is a schematic diagram illustrating an example of a field system in which a ferromagnetic member is disposed between two magnet arrays each formed in a circular ring shape.

FIG. 4 is a schematic diagram illustrating an example of a field system corresponding to a dual Halbach magnet array formed by employing two magnet arrays each formed in a circular ring shape.

FIG. 5A is a magnetic flux distribution chart for the field system of FIG. 3.

FIG. 5B is a maximum flux distribution chart for the field system of FIG. 4.

FIG. 6A is a schematic diagram illustrating a field system, and illustrates an example of a field system in which a ferromagnetic member is disposed between two magnet arrays.

FIG. 6B is a schematic diagram illustrating a field system, and illustrates an example of a field system in which a dual Halbach magnet array is formed by two magnet arrays.

FIG. 7A is a magnetic flux distribution chart of the magnet arrays of FIG. 6A.

FIG. 7B is a magnetic flux distribution chart of the magnet arrays of FIG. 6B.

FIG. 8A is a graph illustrating changes to magnetic flux density with respect to electric angle, and illustrates changes on a center line of the field system in FIG. 6B.

FIG. 8B is a graph illustrating changes to magnetic flux density with respect to electric angle, and illustrates changes in the vicinity of an outer peripheral side surface of the cylindrical body in FIG. 6A.

FIG. 8C is a graph illustrating changes to magnetic flux density with respect to electric angle, and illustrates changes in the vicinity of an inner peripheral side surface of the cylindrical body in FIG. 6A.

### DESCRIPTION OF EMBODIMENTS

Detailed description follows regarding exemplary embodiment of the present disclosure, with reference to the drawings.

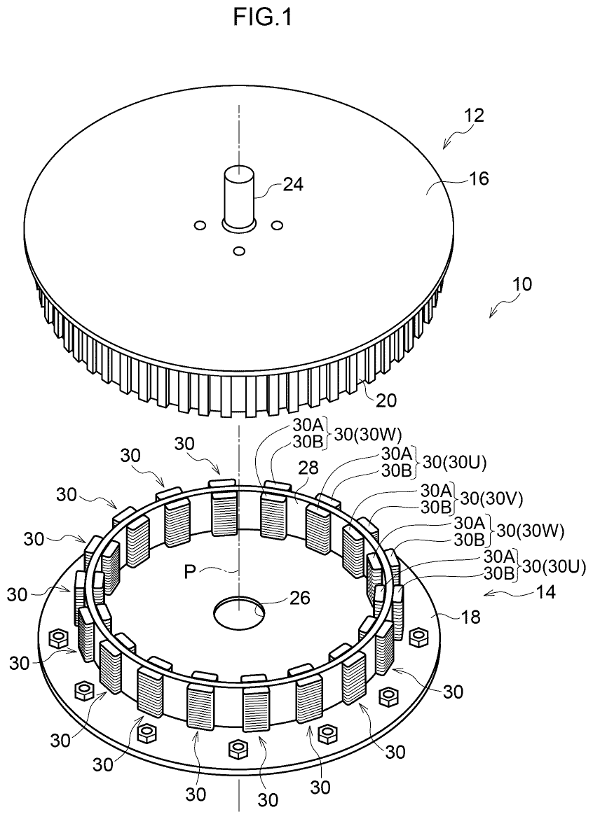

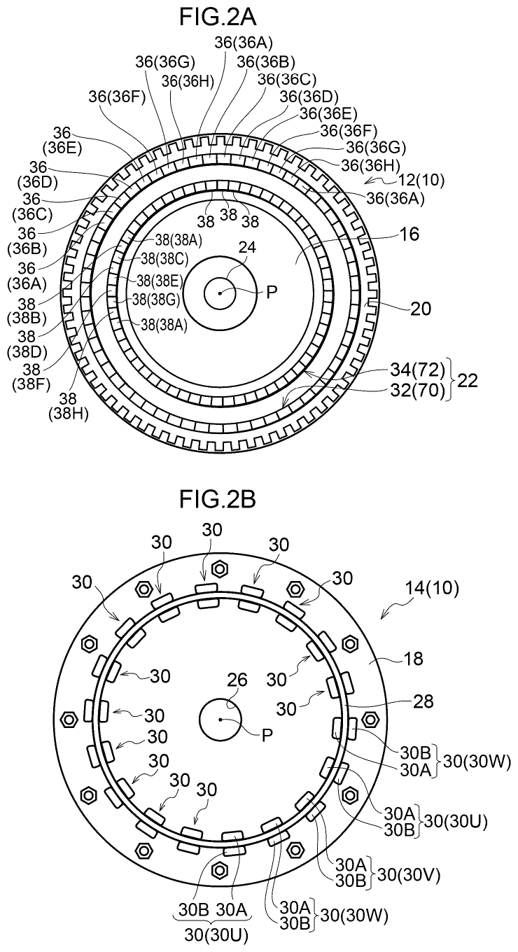

The present exemplary embodiment is applied to a three-phase synchronous electric motor (hereafter referred to as electric motor 10) serving as an example of an electromagnetic device. In FIG. 1 main parts of the electric motor 10 are illustrated in an exploded perspective view, and in FIG. 2A and FIG. 2B the electric motor 10 is illustrated in schematic cross-sections as viewed along an axial direction. Note that FIG. 1 is a schematic perspective view as viewed diagonally from one side in the axial direction of the electric motor 10. Moreover, FIG. 2A is a schematic cross-section as viewed from the axial direction other side of the electric motor 10, and FIG. 2B is a schematic cross-section as viewed from the axial direction one side of the electric motor 10.

As illustrated in FIG. 1, FIG. 2A, and FIG. 2B, the electric motor 10 includes a rotor 12 serving as a moving body, a stator 14 serving as a fixed body, with the rotor 12 and the stator 14 housed in a non-illustrated casing (case).

A plate 16 is disposed in the rotor 12, a plate 18 is disposed in the stator 14, and the plates 16, 18 are each configured in substantially circular plate shapes of a required diameter, and face each other with central axes that are superimposed on each other. Note that in the following explanation, points on the superimposed central axes are points P.

In the rotor 12, an external shell 20 having a substantially circular cylinder shape is disposed at an outer peripheral edge of the plate 16, with the external shell 20 fixed to a face on the plate 18 side of the plate 16 with its central axis superimposed on points P. A field system 22 (omitted from illustration in FIG. 1) is formed on the plate 16 at an inner peripheral side (radial direction inside) of the external shell 20. Furthermore, a shaft 24 is disposed on the plate 16 as a rotation shaft, with the shaft 24 disposed so as to pierce through an axial center portion of the plate 16 and fixed so as to be capable of rotating as one together with the plate 16.

A circular hole 26 is formed so as to pierce through an axial center portion of the plate 18 of the stator 14, with a one end side of the shaft 24 of the rotor 12 disposed so as to pierce through the circular hole 26 and be able to rotate relative thereto. A circular cylinder shaped tube body 28 serving as a support body is disposed on the plate 18, with a ferromagnetic material employed for the tube body 28. The tube body 28 is fixed to the plate 16 side of the plate 18 with a central axis of the tube body 28 superimposed on the central axis of the circular hole 26 (shaft 24).

The tube body 28 is formed with a smooth outer peripheral face and inner peripheral face (lacking indentations or projections), with the inner peripheral face and the outer peripheral face being formed so as to each have a respective constant radius with respect to the points P. An electromagnetic steel sheet, a metal not having a crystalline structure (amorphous metal or the like), and the like may be employed for the tube body 28. Preferably, the tube body 28 in such cases has a structure in which eddy currents do not occur, and may, for example, be configured with a thin thickness, or may be configured by superimposing materials having a thin thickness, with this thereby enabling the magnetic field to be suppressed from being disturbed by eddy currents even though the tube body 28 is disposed in the magnetic field.

Plural coils (armature) 30 are disposed in the stator 14, with the coils 30 configured by air-core coils employing Litz wire of a specific cross-sectional area. The coils 30 are divided into U-phase coils 30U, V-phase coils 30V, and W-phase coils 30W, for a three-phase alternating current power source, with a single set being configured from a coil 30U, a coil 30V, and a coil 30W, and plural sets of the coils 30 arrayed around a circumferential direction of the tube body 28. Note that, for the relative positions of the array (array sequence) of the coils 30 for each phase (30U, 30V, 30W) with respect to the field system 22 (permanent magnets 36, 38, described below), an array capable of rotational driving the electric motor 10 may be applied. The number of sets of the coils 30 (30U, 30V, 30W) and the number of sets in the field system 22 (permanent magnets 36, 38, described below) are determined according to a combination of a number of magnetic poles and a number of slots or the like of the electric motor 10 (omitted from illustration).

Moreover, the coils 30 (30U, 30V, 30W) are divided into two, with coils 30A on the inside and coils 30B on the outside. The coils 30U, 30V, 30W of the coils 30A are disposed on the inside of the tube body 28 and the coils 30U, 30V, 30W of the coils 30B are disposed on the outside of the tube body 28, and the coils 30U, 30V, 30W configured thereby are assigned as pairs with respect to the tube body 28 and to the outside. The coils 30A, 30B are each formed from respective air-core coils 30U, 30V, 30W that have been wound such that the current directions and current values are similar inside similar magnetic fields. In the coils 30A, 30B, the coils 30U are connected together in series, the coils 30V are connected together in series, and the coils 30W are connected together in series.

In the electric motor 10, the plate 18 of the stator 14 is fixed to the casing, with both axial direction end sides of the shaft 24 respectively projecting out from the plates 16, 18 and received in the casing by shaft bearings or the like (omitted from illustration) so as to be capable of rotating. This means that the electric motor 10 is configured with the field system 22 (rotor 12) capable of rotating relative to the stator 14 and the shaft 24 also capable of rotating.

Next, description follows regarding the tube body 28 that supports the field system 22 and the coils 30 in the electric motor 10.

The field system 22 is formed from an outside field system section 32, and from an inside field system section 34 having a smaller outer diameter than the inner diameter of the outside field system section 32, with each formed in a substantially circular cylinder shape (circular ring shape when viewed along the axial direction). In the electric motor 10, the outside field system section 32 functions as one out of the first permanent magnet array or the second permanent magnet array, and the inside field system section 34 functions as the other out of the first permanent magnet array and the second permanent magnet array.

The field system 22 is disposed on the plate 16 such that a central axis of the outside field system section 32 and a central axis of the inside field system section 34 are superimposed on the central axis of the plate 16. Plural permanent magnets 36 are arrayed in the outside field system section 32 along a circumferential direction about a center of the central axis of the plate 16, and plural permanent magnets 38 are arrayed in the inside field system section 34 along a circumferential direction about a center of the central axis of the plate 16, so to form substantially circular cylinder shapes. The rotor 12 is accordingly configured with a double-walled rotor structure including the outside field system section 32 (outer rotor) and the inside field system section 34 (inner rotor), with the outside field system section 32 and the inside field system section 34 being rotated as a single body.

The tube body 28 disposed with the coils 30 is configured overall as a substantially circular cylinder shape (circular rings shape when view along the axial direction). The tube body 28 disposed with the coils 30 has an inner diameter (diameter at an inner peripheral side formed by the coils 30A) larger than an outer diameter of the inside field system section 34, and has an outer diameter (diameter at an outer peripheral side formed by the coils 30B) smaller than an inner diameter of the outside field system section 32. The stator 14 is thereby disposed so as to be inserted between the outside field system section 32 and the inside field system section 34 of the rotor 12 (the field system 22), with the tube body 28 and the coils 30 configured as a single body.

In the electric motor 10, a Halbach magnet array is applied for each of the arrays of the permanent magnets 36 of the outside field system section 32 and the permanent magnets 38 of the inside field system section 34.

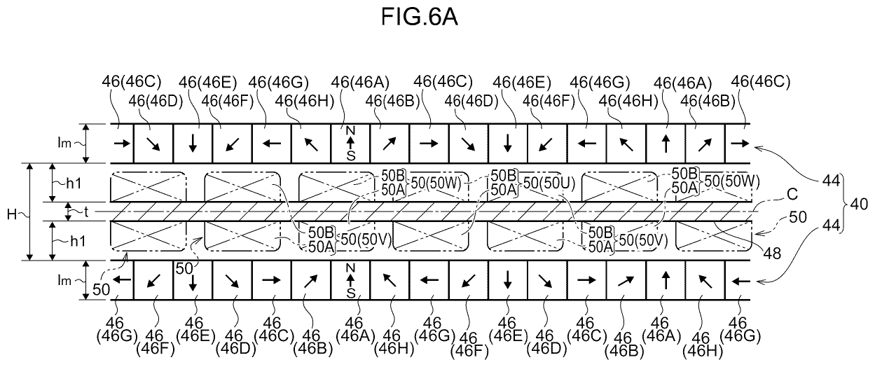

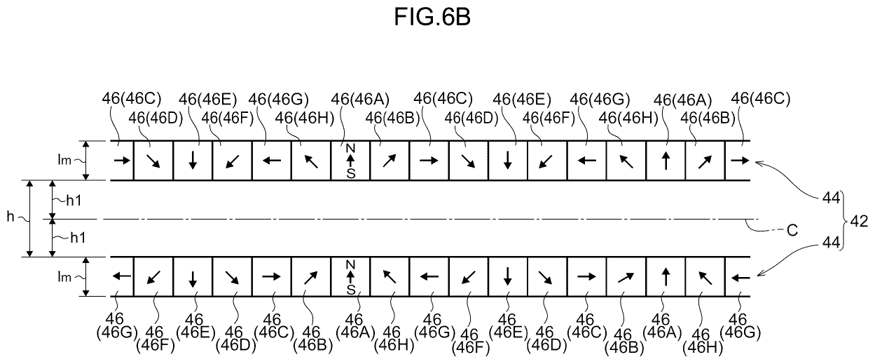

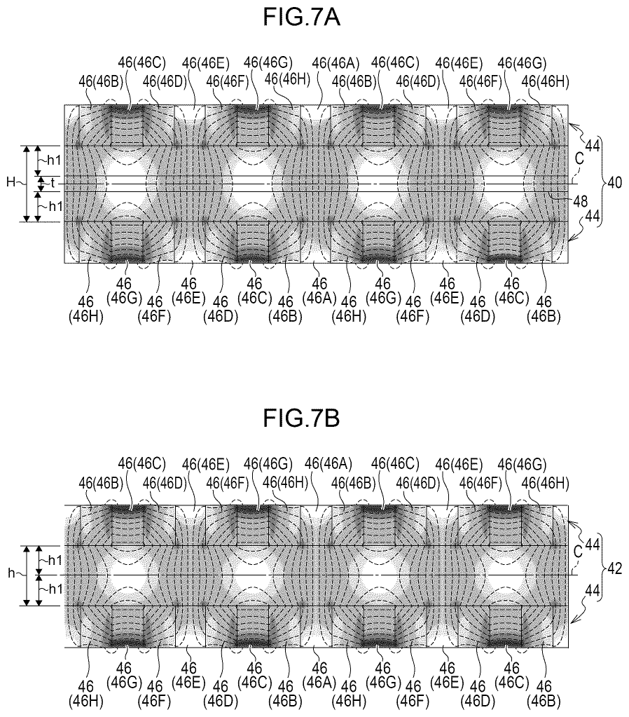

FIG. 6A and FIG. 6B are schematic diagrams illustrating field systems employing a pair of magnet arrays. A field system 40 is illustrated in FIG. 6A, and a field system 42 applied with a dual Halbach magnet array employing a pair of general Halbach magnet arrays is illustrated in FIG. 6B. Moreover, FIG. 7A and FIG. 7B are schematic diagrams illustrating an example of simulation results for magnetic flux distributions (magnetic flux density distributions). FIG. 7A illustrates a magnetic flux distribution in the field system 40 of FIG. 6A, and FIG. 7B illustrates a magnetic flux distribution in the field system 42 of FIG. 6B.

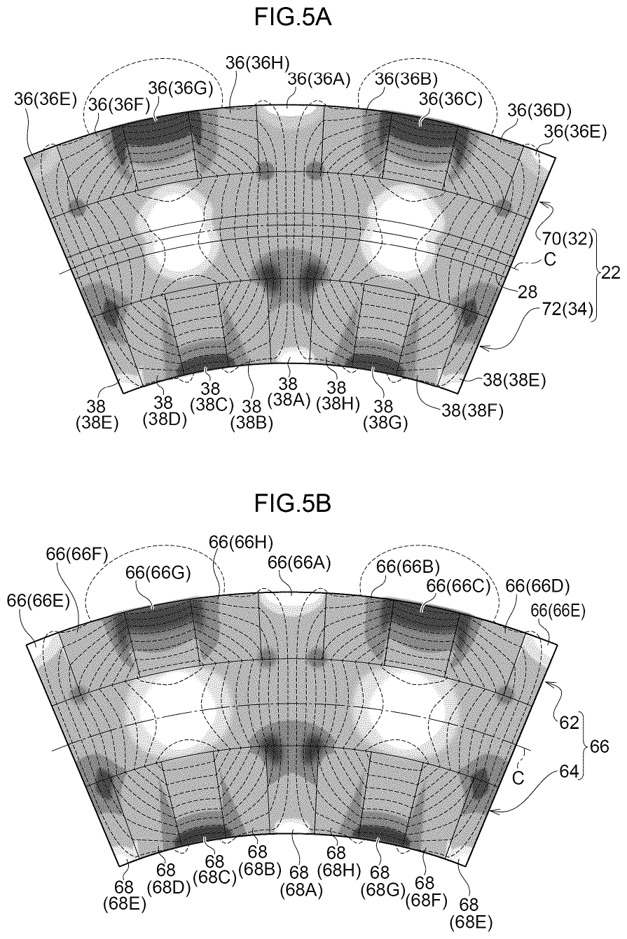

Note that in FIG. 7A and FIG. 7B (similarly also applies to FIG. 5A and FIG. 5B, described later), white portions indicate where the magnetic flux density is lowest, with the color becoming denser as the magnetic flux density becomes higher. Moreover, in the drawings, a magnetization direction inside the permanent magnets is indicated by an arrow pointing in a direction from S pole toward N pole. Moreover, the armature (hereafter referred to as coils 50) is omitted from illustration in FIG. 6B, FIG. 7A, and FIG. 7B.

As illustrated in FIG. 6B and FIG. 7B, magnet arrays (permanent magnet arrays) 44 are employed in the field system 42, and in each of the magnet arrays 44 an angle (divided angle), which results from dividing one cycle of electric angle (2π=360°) by a division number n with division number n being an integer (positive number) of 3 or more, is employed as a setting angle. In the magnet arrays 44, the magnetization directions of the permanent magnets 36 having rectangular shaped cross-sections (which also may be referred to as being rectangular solid shaped or cuboidal shaped) are progressively changed in sequence by the setting angle as they are being arrayed along a one direction.

Although any integer of 3 or more may be employed for the division number n, an integer (positive number) resulting from adding two to a multiple of 3 is more preferable from out of integers (positive numbers) of 3 or more. Thus in the present exemplary embodiment m=2 is applied for n=3·m+2, with the division number n=8 (=3×2+2).

The setting angle is 45° (π/4) for permanent magnets 46 in each of the magnet arrays 44, and permanent magnets 46A to 46H having magnetization directions shifted by 45° are employed arrayed in the sequence permanent magnets 46A, 46B, . . . , 46H along the one direction. This results in the magnet arrays 44 configuring a Halbach magnet array in which the magnetic field on one side in a direction intersecting with the array direction of the permanent magnets 46 is suppressed (weakened) and the magnetic field on the other side is strengthened compared to the magnetic field on the one side. Note that, between the two magnet arrays 44, the permanent magnets 46 of one of the magnet arrays 44 are arrayed in sequence facing toward one side in the one direction, and the permanent magnets 46 of the other of the magnet arrays 44 are arrayed in sequence facing toward the other side in the one direction.

Moreover, in the field system 42, the two magnet arrays 44 face each other such that the magnetic field is strengthened therebetween (in the gap), with a spacing dimension of a gap length h between faces (magnetized faces) of the two magnet arrays 44 facing each other. This means that, in the field system 42, a distance from a center line C between the magnet arrays 44 to respective magnetized faces (faces on the center line C side) of each of the magnet arrays 44 is a similar distance h1 (h1=h/2).

A dual Halbach magnet array is thereby formed by the field system 42, and the field system 42 is able to achieve improved output due to the magnetic field between the magnet arrays being even more strengthened. Moreover, in the field system 42, a stabilization of torque (torque ripple suppression) can be achieved due to the strength of the magnetic fields changing with a substantially sine wave shape in the electric angle direction (circumferential direction) at the center line C of the gap.

On the other hand, as illustrated in FIG. 6A and FIG. 7A, there are a pair of magnet arrays 44 disposed in the field system 40, and the two magnet arrays 44 in the field system 40 face each other so as to reinforce the magnetic fields between each other, similarly to in the field system 42. Moreover, a ferromagnetic member 48 is disposed between the two magnet arrays 44 in the field system 40. A ferromagnetic material is employed for the ferromagnetic member 48, with the ferromagnetic member 48 configured in a plate shape having a specific thickness (thickness dimension) t. Moreover, the ferromagnetic member 48 is disposed such that a center line in the thickness direction thereof is superimposed on the center line C between the magnet arrays 44.

Plural coils (armature) 50 are disposed on the ferromagnetic member 48, with the coils 50 for a three-phase alternating current power source separated into U-phase coils 50U, V-phase coils 50V, and W-phase coils 50W. The coils 50 (50U, 50V, 50W) are divided into two, coils 50A and coils 50B, with the coils 50A arranged on one face of the ferromagnetic member 48, and the coils 50B arranged at the other face of the ferromagnetic member 48. The coils 50A, 50B are wound such that the current directions and current values are similar to each other when inside a similar magnetic field. In the coils 50 (coils 50U, 50V, 50W), the coils 50U, 50V, 50W on the coils 50A side are respectively connected together in series to the corresponding coils 50U, 50V, 50W on the coils 50B side. Note that, the array (array sequence) of the coils 50 (50U, 50V, 50W) for each phase and the relative position with respect to the permanent magnets 46 should be prescribed array and relative positions. For example, a configuration applied (omitted from illustration) is one in which a center position in the array direction of one set of permanent magnets 46 (46A to 46H) (for example, the center position of the permanent magnets 46E) is superimposed on a center position of coils 50 (50U, 50V, or 50W) of the same phase.

A mirror method for an electric field can also be applied (is satisfied) in a magnetic field.

In such case, a case is assumed such that magnetic saturation due to the magnetic force due to one of the magnet arrays 44 does not occur in the ferromagnetic member 48. In such cases, a mirror image (magnetic mirror image) of one magnet array 44 appears to be generated (is reflected) at the face on the one magnet array 44 side of the ferromagnetic member 48. The mirror image of the one magnet array 44 reflected at the ferromagnetic member 48 corresponds to the other magnet array 44.

Moreover, magnetic saturation readily occurs in the ferromagnetic member 48 when magnetic flux generated from only one of the magnet arrays 44 is concentrated. In particular, magnetic saturation occurs more easily when the thickness t of the ferromagnetic member 48 is thin than when the thickness t is thick. When magnetic saturation occurs in the ferromagnetic member 48 then a disturbance occurs in the magnetic flux density distribution in the gap, causing the generation of torque ripple or the like.

In the field system 40, the two magnet arrays 44 are disposed so as to sandwich the ferromagnetic member 48, and the ferromagnetic member 48 has a higher magnetic permeability and smaller magnetoresistance than air or the like. This means that the magnetic flux due to one of the magnet arrays 44 inside the ferromagnetic member 48 is counteracted by the magnetic flux due to the other magnet array 44.

Thus in the field system 40, magnetic saturation can accordingly be prevented from occurring in the ferromagnetic member 48. Namely, as illustrated in FIG. 7A and FIG. 7B, a magnetic field similar to that of the field system 42 can be formed in the field system 40 by making the distances from the magnetized faces of each of the two magnet arrays 44 to the ferromagnetic member 48 the same as each other. Note that the magnetic fluxes inside the ferromagnetic member 48 do not counteract each other in cases in which the ferromagnetic member 48 is disposed shifted toward one out of the two magnet arrays 44, and so this results in disturbance occurring in the magnetic field between the two magnet arrays 44.

In contrast to the gap length h (h=h1+h1=2×h1) in the field system 42, a gap length H in the field system 40 is set to H=2×h1+t(=h1+h1+t=h+t). Adopting this approach means that similar advantageous effects are obtained in the field system 40 having the ferromagnetic member 48 disposed between the magnet arrays 44 to those of the field system 42 applied with a dual Halbach magnet array, and the field system 40 exhibits the advantageous effects of a dual Halbach magnet array.

Thus in the field system 40 in which the ferromagnetic member 48 is disposed between the two magnet arrays 44, a similar magnetic field can be formed to that of the field system 42 not disposed with the ferromagnetic member 48 by disposing the ferromagnetic member 48 at the center position of the magnet arrays 44.

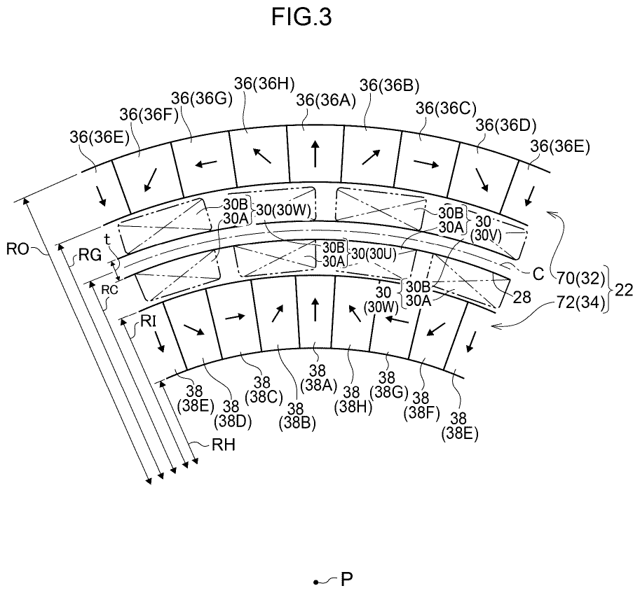

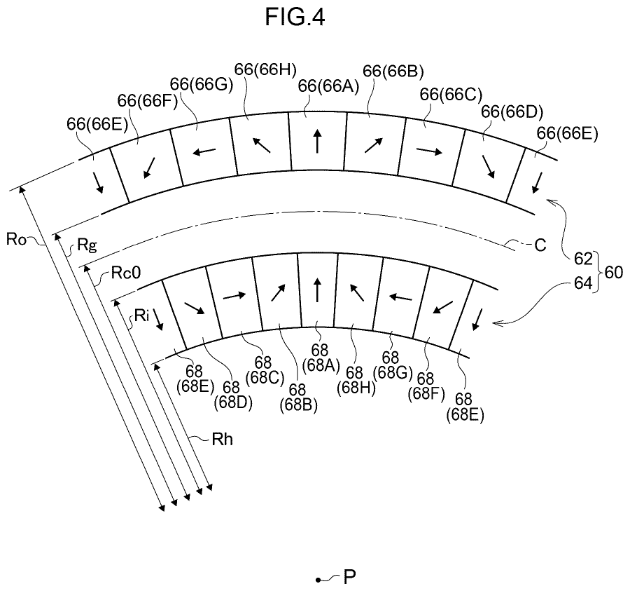

FIG. 3 and FIG. 4 are schematic diagrams illustrating examples of magnet arrays when permanent magnets have been arrayed in a substantially circular cylinder shape (circular ring shape when view along the axial direction). Moreover, FIG. 5A and FIG. 5B are schematic diagrams illustrating examples of simulation results for magnetic flux distribution (magnetic flux density distribution), with FIG. 5A corresponding to the magnet array of FIG. 3, and FIG. 5B corresponding to the magnet array of FIG. 4.

A field system 60 is illustrated in FIG. 4 and FIG. 5B, with magnet arrays (permanent magnet arrays) 62, 64 employed in the field system 60. In the magnet arrays 62, 64, from out of integers (positive numbers) of 3 or more, a number resulting from adding 2 to a multiple of 3 is employed as the division number n applied to the Halbach magnet array, with the division number n=8 being applied in the magnet arrays 62, 64 similarly to in the magnet arrays 44 of the field systems 40, 42.

In the magnet array 62, permanent magnets 66 (66A to 66H) based on the division number n=8 are arrayed in sequence along the circumferential direction at a specific diameter centered on points P. Moreover, in the magnet array 64, permanent magnets 68 (68A to 68H) based on the division number n=8 are arrayed in sequence along the circumferential direction at a diameter, centered on points P, that is smaller than the diameter of the magnet array 62. This means that the magnet array 64 is disposed in the field system 60 at the inside of and facing the magnet array 62, with the permanent magnets 66, 68 facing each other such that the magnet arrays 62, 64 reinforce the magnetic fields between each other.

Moreover, the magnet arrays 62, 64 are each a Halbach magnet array, and in the field system 60 a dual Halbach magnet array is formed by the magnet arrays 62, 64 by disposing the magnet arrays 62, 64 facing each other so as to reinforce the magnetic field between each other.

The field system 60 is formed by isometric change of the field system 42 (see FIG. 6B and FIG. 7B) in which the magnet arrays 44 are disposed parallel to each other. When doing so, the two magnet arrays 44 in the field system 42 have equivalent volumes to each other. In contrast thereto, a volume ratio in the field system 60 between the outside magnet array 62 and the inside magnet array 64 is modified so as to be equivalent to a ratio between a gap (void) volume further outside than the center line C of FIG. 4, and the gap volume at the inside thereof. In the following, to simplify explanation, the permanent magnets 46 that are the source of the permanent magnets 66, 68 are assumed to have a volume of a square shaped cross-section (a cuboid) of length (length dimension) of 1 m for one side.

As illustrated in FIG. 4, in isometric change, the relationships of following Equation (1) to Equation (8) are satisfied, wherein a cross-sectional area ratio between the radial direction cross-section of the permanent magnets 68 of the inside magnet array 64 and the same portion prior to deformation (a radial direction cross-section of the permanent magnets 46 of the magnet arrays 44 corresponding to the magnet array 64) is αᵢ, a cross-sectional area ratio between the radial direction cross-section of the permanent magnets 66 of the outside magnet array 62 and the same portion prior to deformation (the radial direction cross-section of the permanent magnets 46 of the magnet arrays 44 corresponding to the magnet array 62) is αₒ, ½ the total surface area of the radial direction cross-section of the permanent magnets 66, 68 in the magnet array 62 and the magnet array 64 is S_{g}, a ratio of surface area of the radial direction cross-section of the gap with respect to an average cross-sectional area in the radial direction for each of the permanent magnets 68 of the inside magnet array 64 and the permanent magnets 66 of the outside magnet array 62 is a, and a length of one side when converted into a permanent magnet 46 having a square cross-section prior to deformation is lm. Note that Nm is a number of one cycle's worth of the division number n on the center line C.

$${α}_{i} = \frac{2 ( π {R}_{c 0}^{2} - π {R}_{i}^{2} )}{{aS}_{g}} \qquad ( 1 )$$

$${α}_{o} = \frac{2 ( - π {R}_{c 0}^{2} + π {R}_{g}^{2} )}{{aS}_{g}} \qquad ( 2 )$$

$${α}_{i} {S}_{g} = - π {R}_{h}^{2} + π {R}_{i}^{2} \qquad ( 3 )$$

$${α}_{o} {S}_{g} = - π {R}_{g}^{2} + π {R}_{o}^{2} \qquad ( 4 )$$

$${aS}_{g} = π {R}_{g}^{2} - π {R}_{i}^{2} \qquad ( 5 )$$

$${R}_{c 0} = \frac{{R}_{g} + {R}_{i}}{2} \qquad ( 6 )$$

$${l}_{m} = \frac{2 π {R}_{c 0}}{{N}_{m}} \qquad ( 7 )$$

$${S}_{g} = {N}_{m} {l}_{m}^{2} \qquad ( 8 )$$

In the above, lm, Rₒ, Rᵢ, R_{g}, and Rₕ satisfy the relationships of following Equation (9) to Equation (13). Note that Rₒ is the outer diameter of the magnet array 62, R_{g} is the inner diameter of the magnet array 62, R_{c0} is the radius of the center line C, Rᵢ is the outer diameter of the magnet array 64, and Rₕ is the inner diameter of the magnet array 64.

$${l}_{m} = \frac{2 π {R}_{c 0}}{{N}_{m}} \qquad ( 9 )$$

$${R}_{o} = {R}_{c 0} \sqrt{\frac{{N}_{m}^{2} + 2 ( 2 + a ) {N}_{m} π + a ( 2 + a ) {π}^{2}}{{N}_{m}^{2}}} \qquad ( 10 )$$

$${R}_{i} = {R}_{c 0} - \frac{a π {R}_{c 0}}{{N}_{m}} \qquad ( 11 )$$

$${R}_{g} = {R}_{c 0} + \frac{a π {R}_{c 0}}{{N}_{m}} \qquad ( 12 )$$

$${R}_{h} = {R}_{c 0} \sqrt{\frac{{N}_{m}^{2} - 2 ( 2 + a ) {N}_{m} π + a ( 2 + a ) {π}^{2}}{{N}_{m}^{2}}} \qquad ( 13 )$$

The main variables in an electric motor can be expressed by R_{c0}, Nm, a. In this case, “a” is a value determined for each electric motor to give a maximum amount of flux linkage for a total mass of the permanent magnets 66, 68. Moreover, by determining R_{c0}, Nm, and a, the electric motor 10 applied with the field system 60 is obtained by employing each value of the electric motor (in particular Rₕ, Rᵢ, R_{c0}).

Generally, a pole pitch τ in a pair of Halbach magnet arrays (a dual Halbach magnet array) is taken as being τ=n·lm/2, from the division number n and the length lm of one side of the permanent magnets 46. Moreover, the pole pitch τ on the center line C (gap center) is obtained as τ=(n·π·R_{c0})/Nm, from one cycle's worth of a division number Nm and from the radius R_{co} of the gap center (center line C). Note that by making the cross-section profile of the permanent magnets 46 a square profile with a one side length lm, the length of the cross-sectional perimeter is the shortest per unit surface area, so as to suppress the overall dimensions of the field system 42 as much as possible.

In the field system 42 (a field system formed by a dual Halbach magnet array), the gap length h where the maximum amount of flux linkage is obtained at the center line C (gap center) falls in a range of 0.5 to 2.0 times the pole pitch τ (i.e. 0.5τ≤h≤2.0τ), the gap length in the field system 60 set according to the above relationship equations also falls within the range of 0.5 to 2.0 times the pole pitch τ.

On the other hand, the field system 22 of the electric motor 10 includes the outside field system section 32 and the inside field system section 34 that each have a circular cylinder shape, with the circular cylinder shaped tube body 28 disposed between the outside field system section 32 and the inside field system section 34. This means that field system 22 corresponds to FIG. 3 and FIG. 5A.

Namely, as illustrated in FIG. 3 and FIG. 5A, the outside field system section 32 is formed in the field system 22 with the permanent magnets 36A to 36H applied with the division number n=8 arrayed in sequence (facing toward one side in the circumferential direction) along the circumferential direction at a specific radius centered on points P. Moreover, the inside field system section 34 is formed in the field system 22 with the permanent magnets 38A to 38H applied with the division number n=8 arrayed in sequence (facing toward the other circumferential direction side) along the circumferential direction at a radius centered on points P smaller than the radius of the outside field system section 32. The tube body 28 using a ferromagnetic material is also disposed between the outside field system section 32 and the inside field system section 34.

Herein, centered on the points P in the field system 22, the outer diameter of the outside field system section 32 is RO, the inner diameter of the outside field system section 32 is RG, the outer diameter of the inside field system section 34 is RI, and the inner diameter of the inside field system section 34 is RH. Moreover, in the field system 22 the radius RC of the center line C is similar to the radius R_{cO} of the center line C in the field system 60. Furthermore, in cases configured by a dual Halbach magnet array similar to the field system 60 in the field system 22, the relationship of H=h+τ between the field system 40 and the field system 42 is obtained between the field system 22 and the field system 60.

Thus in the field system 22, due to RO, RG, RC, RI, and RH satisfying the relationships expressed by each of the Equations (14) to (18), the field system 22 obtains similar advantageous effects to those of the field system 60. Note that the array (array sequence) of the coils 30 (30U, 30V, 30W) for each phase and the relative positions with respect to the permanent magnets 36, 38 should be prescribed array and relative positions. For example, a configuration (omitted from illustration) may be applied in which center positions of coils 30 (30U, 30V, or 30W) for the same phase are superimposed on the center positions in the array direction of one pair of the permanent magnets 36 (36A to 36H), 38 (38A to 38H) (for example on the center position of the permanent magnet 36E and the center position of the permanent magnet 38E).

$$RO = ( ( {R}_{c 0} + t / 2 ) / {R}_{c 0} ) {R}_{O} \qquad ( 14 )$$

$$RG = ( ( {R}_{c 0} + t / 2 ) / {R}_{c 0} ) {R}_{g} \qquad ( 15 )$$

$$RC = {R}_{c 0} \qquad ( 16 )$$

$$RI = ( ( {R}_{c 0} + t / 2 ) / {R}_{c 0} ) {R}_{I} \qquad ( 17 )$$

$$RH = ( ( {R}_{c 0} + t / 2 ) / {R}_{c 0} ) {R}_{b} \qquad ( 18 )$$

In the electric motor 10 configured in such a manner, the coils 30 (30U, 30V, 30W) of the three phases provided to the stator 14 are disposed in the rotor 12 between the outside field system section 32 and the inside field system section 34 that together form the field system 22, and the outside field system section 32 and the inside field system section 34 are able to rotate as a pair with respect to the coils 30. This means that, in the electric motor 10, the outside field system section 32 and the inside field system section 34 are rotated as a single body by three-phase alternating current power being supplied to the coils 30 (30U, 30V, 30W), and the shaft 24 is rotated.

Thus in the electric motor 10, due to the coils 30 being configured as air-core coils, the inductance of the coils 30 can be made small, enabling back electromotive force to be suppressed from being induced in the coils 30, and enabling a high rated rotation speed to be achieved in the electric motor 10. Moreover in the electric motor 10, cogging torque can be prevented from being generated due to the coils 30 being air-core coils.

Moreover, in the electric motor 10, a Halbach magnet array is applied to both the outside field system section 32 and the inside field system section 34 of the field system 22, and the field system 22 is accordingly configured as a dual Halbach magnet array. Thus in the electric motor 10 the power density can be raised compared to case not applied with the field system 22.

Heat generation generally occurs in coils of an electric motor due to current flowing in the coils (armature). When this occurs, a large cooling effect is not able to be obtained when the coils need to be cooled by air in the gap alone, and so current flowing in the coils needs to be suppressed. This means that achieving a high power density in an electric motor is difficult due to not being able to achieve a large output when current flowing in the coils is low (a small current value).

Thus in the electric motor 10 of the present disclosure, the tube body 28 is provided to the stator 14, and the coils 30 are attached to the tube body 28. A ferromagnetic material that is a metal is employed for this tube body 28, and the tube body 28 has a thermal conductivity that is extremely high compared to configurations in which there is air or a resin material in the gap between the outside field system section 32 and the inside field system section 34.

Thus heat disposal of the heat generated by the coils 30 in the electric motor 10 is able to be performed efficiently by cooling the tube body 28. In the electric motor 10 the current flowing in the coils 30 can accordingly be increased and the output can be increased. Moreover, the increase in radial direction dimension of the electric motor 10 is limited to the thickness of the tube body 28, enabling the power density in the electric motor 10 to be improved (raised).

The cooling of such a tube body 28 can be achieved by applying various methods, such as a method to cool the tube body 28 by cooling the plate 18 of the stator 14, a method to cool the tube body 28 by providing an end portion of the tube body 28 on the opposite side to the coils 30 so as to project out from the plate 18, and then cooling from the portion projecting out from the plate 18. The tube body 28 in the electric motor 10 is accordingly able to be cooled easily. Moreover, in the electric motor 10 a temperature rise in the coils 30 can be efficiently suppressed by using the tube body 28 and so, for example, there is no longer a need to increase the cross-sectional area of wiring (Litz wires) employed in the coils 30 to lower the heat generation (heat generation amount) for a given current.

In cases in which a member other than the air-core coils 30 is disposed between the outside field system section 32 and the inside field system section 34, disturbance would occur in the magnetic field between the outside field system section 32 and the inside field system section 34, leading to a fall in power density and to the occurrence of cogging torque that is a cause of vibration.

In contrast thereto, in the electric motor 10 the ferromagnetic tube body 28 having a constant thickness t is disposed such that the center line of the tube body 28 is superimposed on the center line C between the outside field system section 32 and the inside field system section 34, in a configuration such that the spacing (gap length) between the outer peripheral face of the tube body 28 and the field system face of the outside field system section 32 is similar to the spacing (gap length) between the inner peripheral face of the tube body 28 and the field system face of the inside field system section 34.

Thereby, as illustrated in FIG. 5A to FIG. 5B (see also FIG. 7A to FIG. 7B), due to being at a constant thickness t using the ferromagnetic material having a high magnetic permeability, disturbance does not occur in the magnetic field between the outside field system section 32 and the inside field system section 34, even though the tube body 28 is provided.

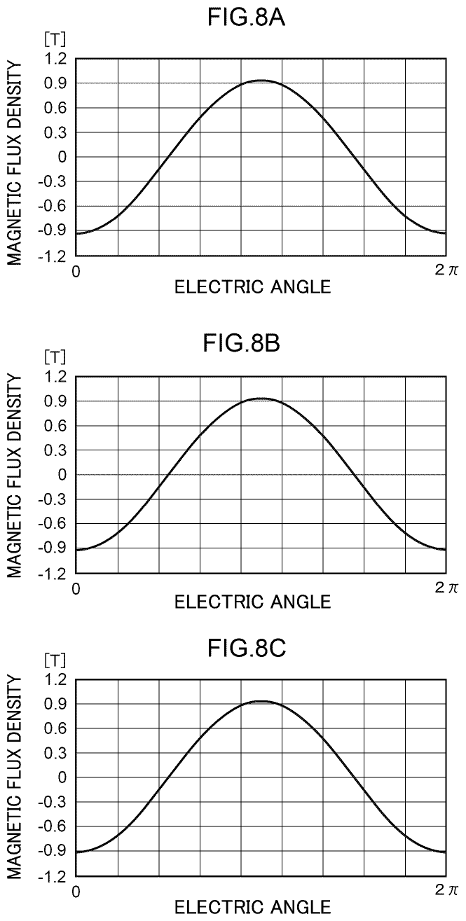

FIG. 8A to FIG. 8C are graphs illustrating changes to magnetic flux density with respect to electric angle. Note that, FIG. 8A illustrates changes to magnetic flux density along the center line C in the field system 60, FIG. 8B illustrates changes to magnetic flux density in the field system 22 at the vicinity of (proximity to) the surface of the tube body 28 on the outside field system section 32 side, and FIG. 8C illustrates changes to magnetic flux density in the field system 22 at the vicinity of (proximity to) the surface of the tube body 28 on the inside field system section 34 side. Moreover, a positive or negative sign of the magnetic flux density in the figures of FIG. 8A to FIG. 8C indicates the magnetic field direction.

As illustrated in FIG. 8A, in the field system 60 applied with the dual Halbach magnet array, the magnetic flux density at the center line C changes in a sine wave shape according to electric angle. This means that the field system 60 exhibits the advantageous effect of a dual Halbach magnet array of being able to suppress torque ripple from occurring.

Moreover, as illustrated in FIG. 8B and FIG. 8C, in the field system 22, the magnetic flux density changes in a sine wave shape, according to electric angle at the faces on both the outside field system section 32 side and the inside field system section 34 side of the tube body 28, similar to the changes on the center line C of the field system 60. Thus, even in the field system 22 in which the tube body 28 is provided, advantageous effects are exhibited similar to those of the field system 60, and the power density can be raised in the electric motor 10 provided with the field system 22 and also vibration and the like arising from a rise in torque ripple can be suppressed from occurring.

On the other hand, in the electric motor 10 the number of divisions that determine the setting angle in the magnetization direction of the permanent magnets 36, 38 of the outside field system section 32 and the inside field system section 34 is an integer resulting from adding 2 to a multiple of 3.

In a synchronous electric motor of three-phases (a three-phase synchronous electric motor), it is known that, from out of spatial harmonic components contained in magnetic flux density for one cycle of electric angle, generally there is no generation (there is suppression) of torque ripple attributable to spatial harmonic components of orders that are multiples of 3 (3^{rd} order, 6^{th} order, . . . ). Moreover, the amplitude of spatial harmonic components is affected by torque ripple, and due to the amplitude of lower order spatial harmonic components from out of the spatial harmonic components being greater than the amplitude of higher order spatial harmonic components therein, the lower order spatial harmonic components particularly affect torque ripple.

In the electric motor 10, due to the coils 30 being in close proximity to the magnetized faces of the outside field system section 32 and the inside field system section 34, the amount of flux linkage linking with the coils 30 can be increased (see FIG. 5A, FIG. 5B, FIG. 7A, and FIG. 7B). A large output torque can accordingly be achieved even in the electric motor 10. However, the spatial harmonic components are larger in the vicinity of the surfaces (magnetized faces) of the outside field system section 32 and the inside field system section 34, and so torque ripple caused by spatial harmonic components is liable to occur.

Thus in the electric motor 10 the division number n is an integer resulting from adding 2 to a multiple of 3, enabling spatial harmonic components in the vicinity of the magnetized faces of both the outside field system section 32 and the inside field system section 34 to be suppressed, thereby enabling torque ripple so be even more efficiently suppressed.

Moreover, the coils 30B are disposed on the outside field system section 32 side of the tube body 28 in the electric motor 10, and the coils 30B are disposed on the inside field system section 34 side of the tube body 28. In the electric motor 10, the coils 30B are assigned to the outside field system section 32 side of the tube body 28 and the coils 30A are assigned to the inside field system section 34 side thereof. In the electric motor 10, one or other of the coils 30A or the coils 30B may be disposed on the tube body 28, however assigning the coils 30A, 30B to each side of the tube body 28 enables magnetic fields formed by the outside field system section 32 and the inside field system section 34 to be efficiently employed.

Note that the electric motor 10 has been described as an example in the present exemplary embodiment described above. However, the electromagnetic device of the disclosure may be applied to a generator (three-phase generator), and the electromagnetic device may be any rotary electrical machine, such as an electric motor, a generator, or the like.

Moreover, the electromagnetic device of the disclosure may be configured with a three-phase armature disposed between Halbach magnet arrays, the electromagnetic device may by a linear motor or the like that includes a first magnet array and a second magnet array each formed by plural permanent magnets arrayed in a substantially straight line shape, with an armature disposed between the first magnet array and the second magnet array. An example of such a linear motor is a three-phase linear synchronous motor having a circular cylinder shape, and the linear motor may be configured such that, for an armature, the first magnet array and the second magnet array are moved relative to a pair of armatures, and may be configured such that, overall, the armature is moved between the first magnet array and the second magnet array.

A circular cylinder shaped three-phase linear synchronous motor applied with the present disclosure is equipped with a moving body, configured by a double walled circular cylinder structure formed from the first magnet array and the second magnet array, each formed in a substantially circular cylinder shape and disposed at one side and the other side in a radial direction, and a fixed body that includes a three-phase armature (coils) disposed between the first magnet array and the second magnet array that are formed in substantially circular cylinder shapes, with the moving body being moved relative to the fixed body. The fixed body is configured by plural sets of three-phase coils respectively wound into circular ring shapes and arrayed along an axial direction. Moreover, the first and second magnet arrays are configured from permanent magnets respectively formed in substantially circular ring shapes arrayed along the axial direction while progressively changing respective magnetization directions in a radial direction cross-section (cross-section including a center axis) in sequence by an angle resulting from dividing one cycle of electric angle by a division number n, wherein the division number n is any number of 3 or more. A dual Halbach magnet array is accordingly formed in the moving body by the first magnet array and the second magnet array, enabling relative movement along the array direction of the permanent magnets with respect to the fixed body.

In a three-phase linear synchronous motor, a support body formed in a circular cylinder shape using a ferromagnetic material is employed, and the armature is attached to and supported by the support body. Moreover, the support body is disposed such that a thickness direction center position thereof is superimposed on a center position between the first magnet array and the second magnet array. This means that, efficient disposal of heat from the armature is possible through the support body while still maintaining the advantageous effects of a dual Halbach magnet array formed by the first permanent magnet array and the second permanent magnet array even in a three-phase linear synchronous motor, and an improvement in power density can be achieved.

Furthermore, for a double row of permanent magnets (permanent magnets 46) and a three-phase armature (coils 50) in the field system 40 illustrated in FIG. 6A, a flat plate shape linear motor is configured by imparting a prescribed length along the array direction to the respective permanent magnets. The present disclosure may be applied without causing any difficulty to such a flat plate shape linear motor.

The disclosure described above includes the following aspects.

<1> An electromagnetic device comprising:
a moving body including a first magnet array and a second magnet array each in which a plurality of permanent magnets are arrayed along a one direction while progressively changing respective magnetization directions in sequence by an angle resulting from dividing one cycle of electric angle by a division number n, wherein the division number n is any number equal to or greater than 3, the first magnet array and the second magnet array are disposed separated by a specific gap length and facing at orientations such that magnetic fields of the first magnet array and the second magnet array reinforce each other;
a fixed body including a support body formed at a specific thickness dimension using a ferromagnetic material, the support body disposed between the first permanent magnet array and the second permanent magnet array such that a gap length to the first magnet array is similar to a gap length to the second magnet array, the moving body being moved relative to the fixed body; and
a three-phase armature configured from respective air-core coils disposed on the support body divided respectively between the first magnet array side and the second magnet array side of the support body.
   <2> The electromagnetic device of <1>, wherein the division number n is any number resulting from adding 2 to a multiple of 3.
   <3> The electromagnetic device of <1> or <2>, wherein:
the moving body is configured by a rotor in which the permanent magnets are arrayed in each of the first magnet array and the second magnet array along a circumferential direction centered on a single center point; and
the fixed body is a circular cylinder shaped stator centered on the center point.

The entire content of the disclosure of Japanese Patent Application No. 2022-003866 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. An electromagnetic device comprising:
a moving body including a first magnet array and a second magnet array each in which a plurality of permanent magnets are arrayed along a one direction while progressively changing respective magnetization directions in sequence by an angle resulting from dividing one cycle of electric angle by a division number n, wherein the division number n is any number equal to or greater than 3, the first magnet array and the second magnet array are disposed separated by a specific gap length and facing at orientations such that magnetic fields of the first magnet array and the second magnet array reinforce each other;
a fixed body including a support body formed with constant thickness dimension using a ferromagnetic material, the support body disposed between the first permanent magnet array and the second permanent magnet array such that a gap length to the first magnet array is similar to a gap length to the second magnet array, the moving body being moved relative to the fixed body; and
a three-phase armature configured from respective air-core coils disposed on the support body divided respectively between the first magnet array side and the second magnet array side of the support body.

2. The electromagnetic device of claim 1, wherein the division number n is any number resulting from adding 2 to a multiple of 3.

3. The electromagnetic device of claim 1, wherein:
the moving body is configured by a rotor in which the permanent magnets are arrayed in each of the first magnet array and the second magnet array along a circumferential direction centered on a single center point; and
the fixed body is a circular cylinder shaped stator centered on the center point of the support body.

4. The electromagnetic device of claim 2, wherein:
the moving body is configured by a rotor in which the permanent magnets are arrayed in each of the first magnet array and the second magnet array along a circumferential direction centered on a single center point; and
the fixed body is a circular cylinder shaped stator centered on the center point of the support body.
